(19) United States
(12) Patent Application Publication
(10) Pub. No.: US 2017/0234505 A1
(43) Pub. Date: Aug. 17, 2017

(54) LAMPSHADE MANUFACTURING, FITTING AND ASSEMBLY

(71) Applicant: Design and Deliver, LLC, Charlotte, NC (US)

(72) Inventor: Robert Victor Jones, Charlotte, NC (US)

(73) Assignee: Design and Deliver, LLC, Charlotte, NC (US)

(21) Appl. No.: 15/435,224

(22) Filed: Feb. 16, 2017

Related U.S. Application Data
(60) Provisional application No. 62/295,856, filed on Feb. 16, 2016.

(51) Int. Cl. F21V 1/26; F21V 1/22; B65B 63/04; B26F 1/40; B26D 5/00; F21V 1/14; F21V 17/00

(52) U.S. Cl. CPC F21V 1/26; F21V 1/143; F21V 1/22; F21V 17/002; B26F 1/40; B26D 5/005; B65B 63/04

(57) ABSTRACT

A method for manufacturing a lamp shade cover includes feeding a planar sheet of plastic material to a printer. The method may include printing a design for one or more lampshade covers on the planar sheet of plastic material using the printer and die cutting the planar sheet to create one or more cut-out portions shaped to be bent, folded, or rolled into a three-dimensional lamp shade cover shape. The cut-out portions may include a portion of the design printed using the printer. The method may also include attaching a fastener to a first end and a second end for selectively fastening the first end to the second end to hold the cut-out portions in the three-dimensional lamp shade cover shape.

### CROSS-REFERENCE TO RELATED APPLICATIONS

This application claims the benefit of U.S. Provisional Application No. 62/295,856, filed Feb. 16, 2016, which is hereby incorporated by reference herein in its entirety, including but not limited to those portions that specifically appear hereinafter, the incorporation by reference being made with the following exception: In the event that any portion of the above-referenced application is inconsistent with this application, this application supersedes said above-referenced application.

### STATEMENT REGARDING FEDERALLY SPONSORED RESEARCH OR DEVELOPMENT

Not Applicable

### TECHNICAL FIELD

The present disclosure relates generally to lamps and lampshades and more particularly relates to lampshade systems, lampshade fittings, lampshade manufacturing, and lampshade assembly.

### BRIEF DESCRIPTION OF THE DRAWINGS

FIG. 1 is a perspective view illustrating components of a lampshade system, according to one implementation.

FIG. 2 is a schematic block diagram illustrating a process for manufacturing a lampshade cover, according to one implementation.

FIG. 3 is a plan view illustrating a layout for cut-out shapes for lampshade covers on a sheet of material, according to one implementation.

FIG. 4 is a plan view illustrating another layout for cut-out shapes for lampshade covers on a sheet of material, according to one implementation.

FIG. 5 is a perspective view illustrating packaging of three lampshade covers in a container, according to one implementation.

FIG. 6 is a perspective view illustrating packaging of a lampshade cover in a container, according to one implementation.

FIG. 7 is a perspective side view of illustrating installation or application of a lampshade cover to a transparent lampshade, according to one implementation.

FIG. 8 is an enlarged perspective view of a base of a transparent lampshade having a channel or groove for receiving a lower edge of a lampshade cover, according to one implementation.

FIG. 9 illustrates an exploded view of a lampshade system, according to one embodiment.

FIG. 10 is a schematic flow chart diagram illustrating a method for manufacturing a lampshade cover or wrap, according to one embodiment.

### DETAILED DESCRIPTION OF PREFERRED EMBODIMENTS

Typically, lampshades are made by laminating fabric to styrene to create a “hardback” surface. The “hardback” material can be connected to a top and bottom ring by “hand” rolling the material over the ring or by adhering the material to a top and bottom ring by tape. Because lampshade vendors require fabric to be laminated, they typically stock 30-50 rolls of material and limit their production to what material they have in stock. Thus, consumers are often limited in what designs and patterns they can choose.

Applicant has recognized several additional deficiencies with the current lampshades and lampshade manufacturing. For example, current lampshades are static and cannot be changed or modified without replacing the entire shade because lamps and lampshades are all uniquely fitted with no universal standard. Some do it yourself lampshade kits exist, but they require the consumer to travel to a fabric store, independently purchase fabric, cut it and apply it to a lampshade base using adhesive paper—resulting in a time consuming and cumbersome lamp/shade combination. Furthermore, consumers have a hard time understanding how and where to buy replacement lampshades because there are too many variables related to the shade/lamp fit.

Applicant has recognized that there is a need for a lampshade assembly system for making decorative elements of lampshades uniquely customizable, interchangeable, and easily replaceable without tools. For example, embodiments disclosed herein may prevent requiring users to purchase an entirely new lamp when they want a new lampshade look.

In light of the foregoing, Applicant has generated systems, methods, and devices for interchangeable lampshades and/or lampshade covers. Rather than following the current, multi-step process of making lampshades via the traditional process, Applicant has developed systems, devices, processes and methods to create and print designs on materials such as polypropylene, styrene, or other pliable but semi-rigid substrates. For example, substrates may include materials previously used as backing material substrates for fabric lampshades. These substrates allow printing using the capabilities and creativity of a commercial printer.

By using production process and methods disclosed herein, and by standardizing the size of the wraps or shade covers, designs may be printed on digital printers, off-set printers, and cyan, magenta, yellow, and key (CYMK) printers using ultraviolet (UV) inks, glow in the dark inks, three-dimensional printing, and/or and lenticular printing processes. The lampshade covers or wraps are thus only constrained by the type and size of printer used or available for printing the designs. In one embodiment, the wraps or lampshade covers are printed using a printer whose max print images size is 39.5 inches by 28.35 inches (or 997 mm by 720). The substrates and inks may include safe materials, which can be determined based on material safety data sheets (MSDS) for the materials used for the substrate, printed designs, fasteners, or other parts of the lampshade wraps or covers.

Printing directly on rigid or semi-rigid substrates allow for the creation of unique one of a kind designs such as glow in the dark shade wraps, three-dimensional wraps, lenticular wraps, pre-printed wraps, and do it yourself wraps. The unique printing process also allows for fastening the lampshade wraps or hooks using hook and loop (Velcro) tape or matched pole magnetic tape. For example, fabric systems hook and loop materials to be sewn to the shade material whereas fastener in at least some embodiments disclosed herein can be adhered to the substrate using a glue or adhesive.

The systems and methods disclosed herein may enable interchangeable and releasable lampshade covers. Furthermore, manufacturing embodiments may enable affordable design and manufacturing of lampshade covers so that consumers can easily and affordably change out a shade wrap or cover. Packaging methods and configurations are also disclosed, which may reduce shipping and storage volume for manufactures, shippers, and consumers. Consumes may be able to easily interchange and replace lampshade wraps or covers to obtain a new look for a lamp without replacing the lamp and without requiring the use of tools.

A detailed description of systems and methods consistent with embodiments of the present disclosure is provided below. While several embodiments are described, this disclosure is not limited to any one embodiment, but instead encompasses numerous alternatives, modifications, and equivalents. In addition, while numerous specific details are set forth in the following description to provide a thorough understanding of the embodiments disclosed herein, some embodiments may be practiced without some or all these details. Moreover, for the purpose of clarity, certain technical material that is known in the related art has not been described in detail to avoid unnecessarily obscuring the disclosure.

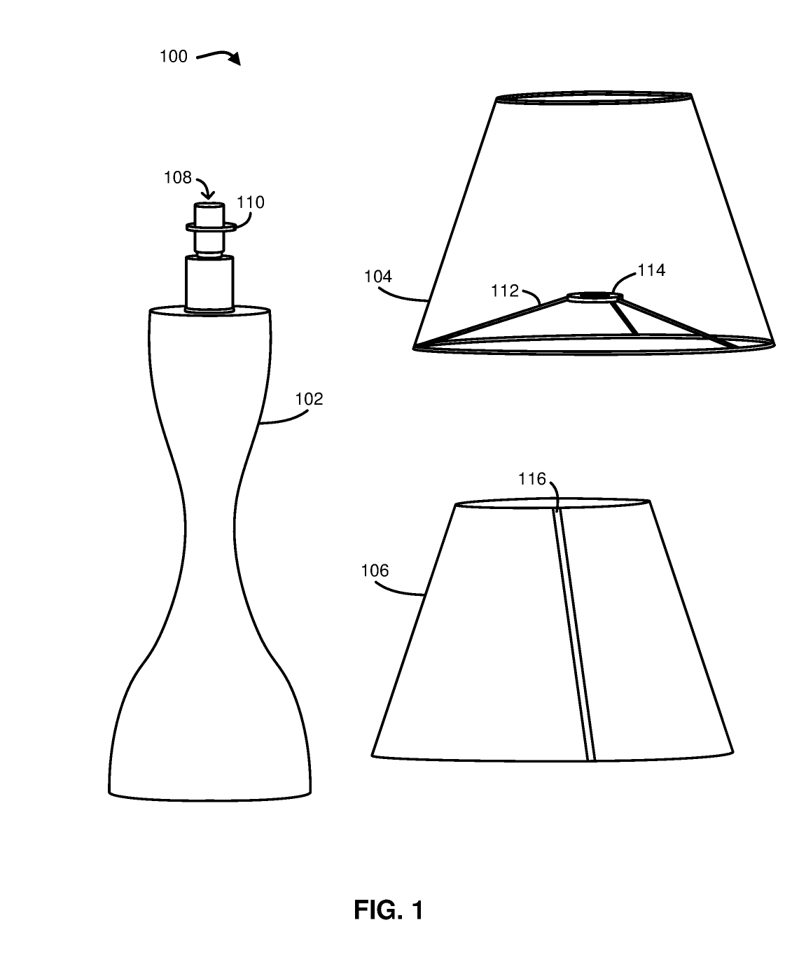

Turning to the figures, FIG. 1 illustrates views of different components of a lampshade system 100, according to at least one embodiment. The lampshade system 100 includes a lamp body 102, a transparent lampshade 104, and a lampshade cover 106 (also referred to herein as lampshade cover or wrap).

The lamp body 102 may include any shape or size body. For example, the lamp body 102 may have a lower surface or base for resting on a table, the floor or other. As a further example, the lamp body 102 may include a surface or mechanism for attaching to a surface such as a floor, wall, ceiling, table, or other structure. The lamp body 102 supports a lamp socket 108 for receiving a light emitter, such as a bulb or lamp. A supporting ring 110 may support the transparent lampshade 104 or support member relative to the lamp body 102.

In one embodiment, the transparent lampshade 104 acts as a support member to support the lampshade cover 106. The support member may be sized and shaped to support the lampshade cover 106 relative to the lamp body 102 to provide an overall configuration or appearance similar to a conventional lampshade. In one embodiment, the clear or transparent lampshade 104 includes a top and bottom wire to provide structured openings at a top and bottom and a transparent material extends between the top and bottom wires. The wire may be secured to a frame or transparent medium with glue or clear tape, so there will be no visible tape residue when the lampshade cover 106 is placed on the transparent lampshade 104 or support member.

The transparent lampshade includes a euro fitting that includes support arms 112 (e.g., wire) and a ring 114 for resting on the supporting ring 110 of the lamp body 102. The purpose of securing the euro fitting to the base wire is to prevent consumers from seeing support wires when using light colored wraps. The position of the supporting ring 110, support arms 112, and ring 114 below a bulb (e.g., below a top or side of a bulb placed within the lamp socket 108 allows for optimized light projection so that lines or shadows are not present on the lampshade cover 106 when it is placed on the transparent lampshade 104. Furthermore, no shadows from the support members (e.g., transparent lampshade 104, support arms 112, or ring 114) are present on a ceiling or wall when the lampshade system 100 is placed in a room.

The lampshade cover 106 is shown in a lampshade shape with a fastener 116 securing opposing edges of the lampshade cover 106. With the fastener 116 securing the opposing edges, the lampshade cover 106 is in the lampshade shape and may be placed (e.g., dropped or placed from above) on the transparent lampshade 104 or other support member.

The lampshade cover 106 may include at least one of a plurality of semi-rigid materials with a printed pattern and that is cut to fit over the transparent lampshade 104. In one embodiment, no supportive backing is required for the lampshade wrap. For example, the lampshade cover may be formed from a sheet of material that holds a lampshade shape when the fastener 116 is secured. The lampshade cover 106 may be made of any material, such as styrene or polypropylene, with sufficient thickness or strength to provide the needed rigidity.

The cooperating detachable fastener(s) 116 may be positioned on opposing ends of each lampshade cover 106. Each detachable fastener 116 may be any fastener known in the art for fastening or removably securing one object to another including, for example, standard push-button snaps, hook and loop (e.g., Velcro) fasteners, adhesive substances, glues, combinations thereof, and the like. It should also be noted that the detachable fasteners 116 may be configured in any array and/or number, so long as the fasteners function in accordance with the present invention as described herein. The detachable fasteners 116 on opposing ends facilitate the lampshade cover 106 to be rolled up into a cylindrical tube, in a storage configuration, during storage and transportation, and subsequently unrolled to an operative configuration for wrapping the lampshade cover 106. The lampshade shape configuration may have a top diameter that is smaller than the bottom diameter, as illustrated in FIG. 1. The lampshade cover 106 will be dimensioned and adapted to be placed on top of the transparent lampshade 104 to be maintained in a lampshade position over the lamp body 102 and any bulb.

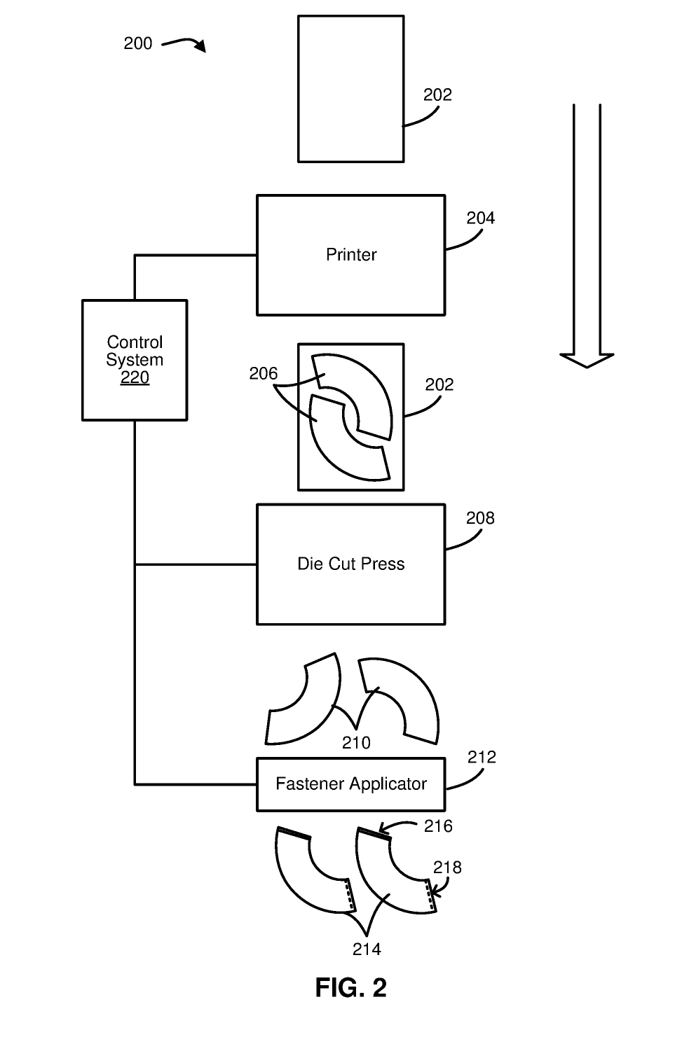

FIG. 2 is a schematic diagram illustrating a process 200 for manufacturing a lampshade cover. The process 200 begins and a sheet 202 of semi-rigid material is fed into a printer 204. In one embodiment, the sheet 202 include a sheet of polypropylene, styrene or other plastic material. In one embodiment, the sheet 202 may include a thickness that allows the sheet 202 to bend in a direction normal to its surface but prevents bending or deforming in a direction parallel to the surface. In one embodiment, the sheet 202 includes a thickness of about 0.25 mm or greater. In one embodiment, the sheet 202 includes a thickness of about 0.25 mm to about 0.55 mm. In one embodiment, the sheet 202 has a thickness form about 0.35 mm to about 0.45 mm. The thickness of the sheet may vary based on material type, the graphic depiction, design and desired look and effect, expected temperature when mounted on a lamp, or the like to provide a lampshade cover that can hold its shape in a lampshade shape.

The sheet 202 may be opaque, transparent, or semi-transparent. The sheet 202 may have a frosted or other obscuring finish so that it is not fully transparent but allows some amount of light to pass through. A semi-transparent sheet 202 or frosted finish may allow some light to pass through without allowing excessive brightness or glare in a user's eyes. The sheet 202 may be fully transparent and some opacity may be provided by a design printed on the sheet 202. The sheet 202 may be sized to be accommodated by the printer 204. For example, commercial printers with a large printing size may be used to allow for designs and patterns large enough to form a lampshade cover may be used.

The printer 204 prints a design 206 or pattern on the sheet 202. The printer 204 may print any design 206 using any known printing process. According to one embodiment, special printing processes may be used for printing on non-porous material such as plastic materials. Example printing processes may be used including ultraviolet (UV) printing, lenticular printing, or the like.

In one embodiment, the printer 204 prints a design using a UV printing process. UV printing is different from conventional printing in many ways. Instead of having solvents in an ink that evaporate into the air and absorb into paper (or other substrate), UV inks, pastes, or powders dry through a photomechanical process. When the inks are exposed to ultraviolet radiation they turn from a liquid, or paste, to a solid. There is significantly less evaporation of solvents and much less absorption of the ink into the stock.

This is advantageous for many reasons. One of the biggest advantages of UV printing is that there are fewer emissions of volatile organic compounds into the environment since there is no evaporation of the solvents like with conventional inks. Another advantage of UV printing is that the inks can dry on plastic and other non-porous substrates, such as a sheet 202 made of a non-porous plastic. Because the inks dry through a photomechanical process it is not necessary for the ink solvent to absorb into the stock. Basically, if you can get the stock or sheet 202 through the printer 204 you can print on it. This process is different than printing on fabrics and laminating the fabric to a hard surface like typical lampshade manufacturing.

In addition to the advantage of printing on unusual substrates like plastic, UV printing also offers significant advantages when printing on uncoated stocks as well. The solvents in conventional inks absorb very quickly into uncoated stocks. Because of this, less of the solvents evaporate into the air and the printed piece tends to have excessive dot gain and will look muddy or too full. Since UV inks dry when exposed to UV light, the inks do not have the time to soak into the paper. The ink dot is left sitting on top of the uncoated sheet, where it presents a cleaner less contaminated dot, ultimately giving more vibrant color.

The key to printing with UV inks successfully lies in exposing the UV ink to enough ultraviolet energy to cure the ink while not making the substrate too brittle and also achieving an acceptable level of adherence to the substrate. This is extremely difficult because every different substrate has very different characteristics.

In one embodiment, the printer 204 is used to print on a surface that will not be exposed. This may be the case, for example, when the sheet 202 is made of a transparent or semi-transparent material that allows the design to be seen from the opposite side. In some cases, the design may be laminated with a clear thin film or gloss to protect the design from being scratched off or to provide a finish for a desired aesthetic or appearance.

The printer 204 may print a design 206 using CMYK inks to provide full color and high quality appearance and design. In some cases, almost any desired appearance can be achieved due to high dot-per-inch printing. In one embodiment, the printer 204 applies a glow in the dark ink or powder as part of the design. For example, a glow in the dark lampshade cover may be printed using an UV glow in the dark ink with a gloss varnish. The glow-in-the-dark material may be applied over a full surface of the design 206 or may be spot printed to provide a glow-in-the-dark effect only at specific locations. In one embodiment, a combination of glow-in-the-dark and CMYK printing may be performed to provide both color and glow-in-the-dark effects to a design 206.

Glow-in-the-dark or glowing effects may be achieved using luminescent or florescent materials. Luminescent material absorbs energy and emits this as light. This can happen either immediately or over a period of time, such as after a light source is turned off. This light emission, or excitation energy, is called luminescence and does not contribute to the thermal energy of the compound.

Fluorescence is the light emitted from a material when it is exposed to exciting energy or electromagnetic radiation. It is a form of luminescence. Fluorescence also occurs frequently in nature in some minerals and in various biological states in many branches of the animal kingdom. Phosphorescence is the glow in the dark light or afterglow that can be detected by the human eye after the cessation of excitation. Lumens is the unit of luminous flux in the International System, equal to the amount of light given out through a solid angle by a source of one candela intensity radiating equally in all directions. Lumens are used to measure light bulbs as standalone light sources while lighting fixtures are measured by Lux output, also known as lumens per square meter. Typically used to measure the light intensity produced by a lighting fixture. The higher the Lux reading the more light the lighting fixture is producing over a given area. See German norm Din 67510 “Photoluminescent pigments and products—Part 1: Measurement and marking at the producer”, ASTM Committee E12.13 “Photoluminescent Safety Markings”, ASTM E 2073-00, and ASTM E 2030-99 for measurement of photoluminescent properties and safety markings made from photoluminescent materials

In one embodiment, the printer 204 prints a design using a lenticular process. In lenticular printing, two or more different images are loaded into a computer graphics program. By way of example, two images may be used. The program cuts each image into dozens of thin strips and weaves them together so the strips from the first image alternate with the strips from the second. This process is called interlacing. This interlaced images is printed and a transparent plastic layer is printed/placed on top of the interlaced or doubled-up image. The transparent plastic layer \is made of dozens of separate thin, hemi-spherical lenses called lenticles. These refract (bend) the light passing through them so that a viewer sees only half (or some other number) of the printed strips. If the user moves their head back and forth the image flips back and forth too like a kind of visual see-saw.

Each one is a hemispherical plastic lens that magnifies only one of the sliced images underneath it, depending on where the viewer's eyes are in relation to the printed image. Different lenticulars have what's called a different pitch, which is the number of lenticles per inch (LPI). They also work differently at different distances from the viewer. Both these factors—the pitch and the viewing distance—should be considered to make a convincing lenticular print.

For all this to work properly, everything should be printed with incredible precision. The lenticles must be lined up with the underlying images strips. Additionally, the image may need to be adjusted and printed so that it looks exactly right when viewed through a certain piece of lenticular plastic (with a certain “pitch”—or number of lenticles per inch) at a certain viewing distance. In theory, you can show many different images with a lenticular: you could have half a dozen different images, all designed to point in slightly different directions, so that the lampshade cover changes its appearance as a viewer moves relative to the lampshade cover. Lenticular printing may also be used to create three-dimensional holographic images. Furthermore, an appearance of movement can be achieved because the image changes as the viewer moves.

In one embodiment, the printer 204 may perform an additive three-dimensional printing on the sheet 202. For example, shapes that extend upward from the sheet 202 may be built or printed by a 3D printer. Because the designs 206 are meant to be bent or rolled when a lampshade cover is in a lampshade shape, there may be limit on the thickness and/or length/width of 3D feature. However, a desired appearance or texture may be imparted to a design 206 with the help of three dimensional features.

The use of glow in the dark, lenticular printing, and/or 3D printing may allow for designs and appearances not previously possible using fabric materials as the medium for displaying a design for a lampshade cover.

A die cut press 208 cuts out the design 206 from the sheet 202 to produce cut-out portions 210. These cut out portions may have the dimensions desired to form a lampshade, when they are bent and/or rolled into a lampshade configuration or shape. The die cut press 208 may allow for fast and efficient production of lampshade covers because printing may be performed on a sheet 202, which is easier to for a printer 204 to work with and perform accurate printing than an oddly shaped lampshade cover or cut out versus the traditional approach of printing hundreds of yards of fabric and sending it to a laminator to apply the “hard backing” needed to stabilize the material.

A fastener applicator 212 applies and/or attaches fasteners to the one or more cut-out portions 210 to produce one or more lampshade covers 214. The fastener applicator 212 applies or attaches the fasteners to a first end 216 and a second end 218 of the cut-out portion 210. With the fasteners in place, the lampshade covers 214 are in a flattened configuration but may be bent to match the first end 216 and second end 218 to place the lampshade covers 214 in a lampshade shape or lampshade cover configuration.

The fastener applicator 212 may apply any type of fastener such as a hook and loop fastener, buttons and corresponding loops, zippers, magnetic tape, tongue and groove inter-locking cut outs, or the like. In one embodiment, the fastener applicator 212 may attach the fasteners using a glue or adhesive. For example, matched pole magnetic tape may be applied to each of the first end 216 and second end 218. Similarly, a hook and loop fastener (such as Velcro®) may be attached using a tape adhesive or glue. Because the lampshade covers 214 are formed of a plastic, adhesives and glue may provide sufficient bonding strength. With fabrics, sewing or other more expensive or complicated attachment process may have been necessary. Specifically, because, in one embodiment, printing and fastener attachment is performed on a plastic substrate, an adhesive backed fastener may be used. The ease of applying an adhesive backed fastener can reduce production costs for the end consumer, leading to the ability to exchange and/or dispose of lampshade covers 214, in one embodiment.

In one embodiment, a control system 220, which may include a computing system, controls operation of the printer 204, die cut press 208, and/or fastener applicator 212. This can allow for on-the-fly configuration of designs with little or no human manipulation of sheets 202, cut-outs with designs 206, or lampshade covers 214. For example, consumers may remotely select lampshade cover configuration, design, and other aspects that can be automatically configured and implemented by the control system 220. For example, the control system 220 may load a different design to be printed by the printer 204, configure a different size for the die cut press 208, and/or configure a different fastener or application process for the fastener applicator 212. For designs, for example, users may upload or modify designs for upload to the control system 220 via a cloud interface or the Internet.

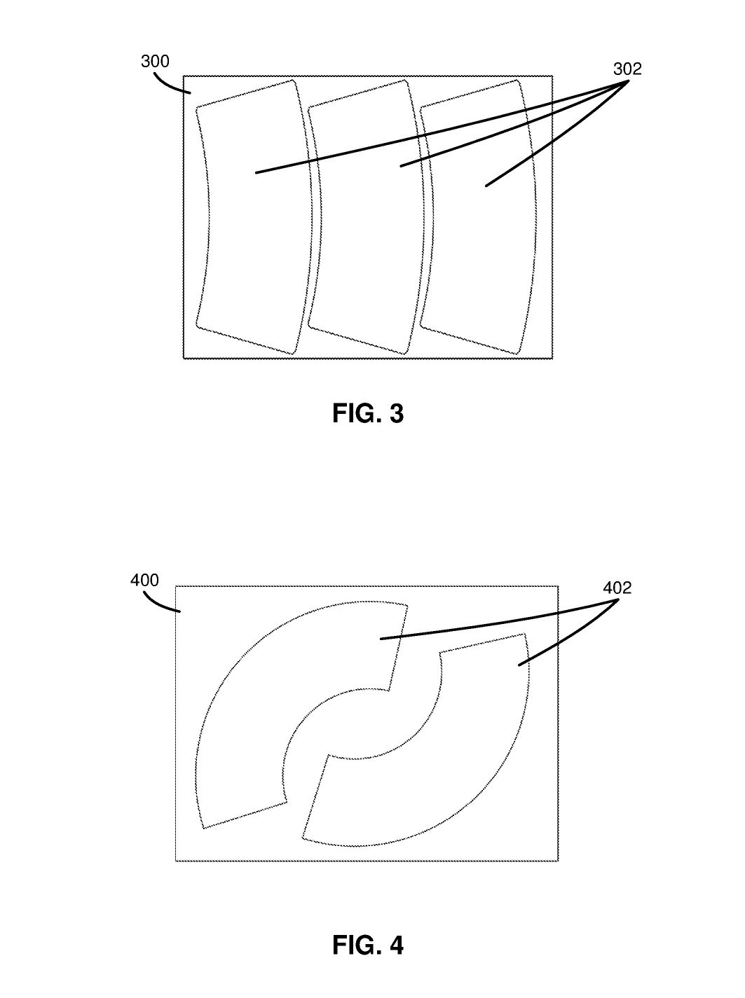

FIG. 3 illustrates a sheet 300 with a layout of cut-out shapes 302 according to one embodiment. FIG. 4 illustrates a sheet 400 with a layout of cut-out shapes 402 according to another embodiment. It should be noted the layout for FIG. 3 fits three cut-out shapes 302 for three lampshade covers while FIG. 4 fits two cut-out shapes 402 for two lampshade covers.

The lampshade covers after the process of FIG. 2 may be in a flattened configuration. The flattened configuration may allow for extremely dense storage, which may allow for reduced storage and shipping costs. For example, conventional lampshades are large and extend into three dimensions but the lampshade covers in the flattened configuration are largely two-dimensional and thus can be stacked in a much more compact matter. Flattened configurations may be conducive to shipping large numbers of lampshade covers in the same container or box. For individual shipping of lampshade covers, or shipping a small number of lampshade covers. The flattened configuration may be undesirable. For example, if a lampshade cover is sold in a single pack or a triple pack, the dimensions of the flattened configuration may be undesirable. In one embodiment, lampshade covers may be individually packaged or packaged in small numbers by rolling up each lampshade cover. This reduces the horizontal dimensions of the lampshade cover.

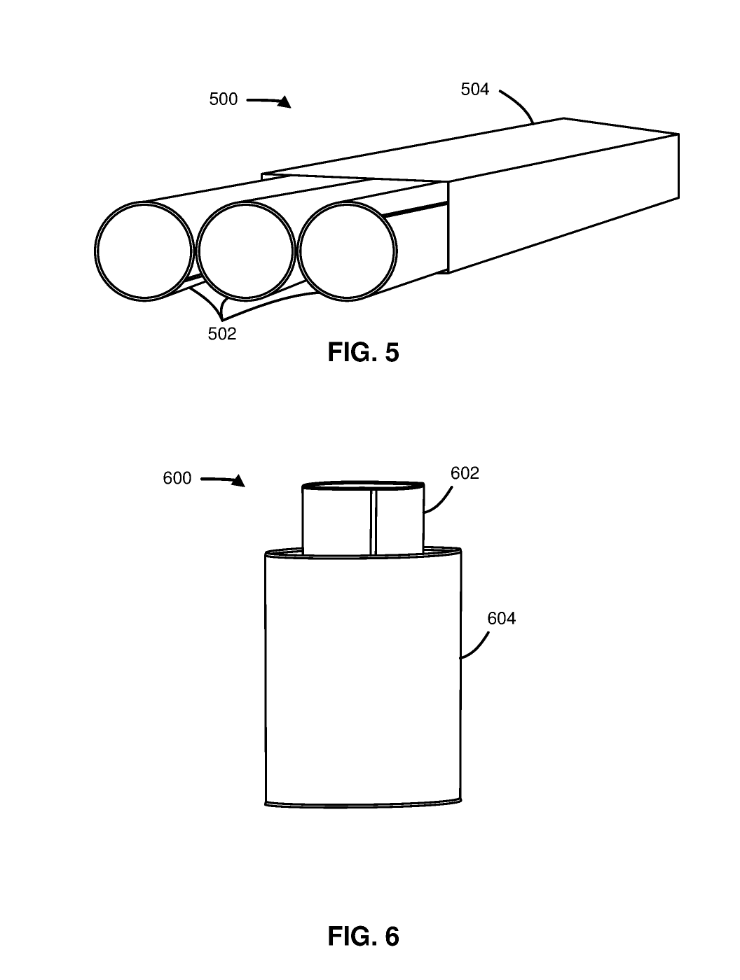

FIG. 5 is a perspective view illustrating packaging 500 of three lampshade covers 502 in a container 504. The lampshade covers 502 are rolled up (similar to a rolled-up paper) and inserted side by side into the container 504. The container 504 is a rectangular box that accommodates all three lampshade covers 502. The packaging 500 allows for a small shipping profile. A cap or lid may also be included. In one embodiment, the cap or lid is reusable to that the container 504 can be used by a consumer for storage when a lampshade cover 602 is not in use.

FIG. 6 is a perspective view illustrating packaging 600 of a single lampshade cover 602 in a container 604. The lampshade cover 602 is rolled up and inserted into the container 604. The container 604 is a cylindrical tube that accommodates the lampshade cover 602. The packaging 600 allows for a small shipping profile. In one embodiment, the cap or lid is reusable to that the container 604 can be used by a consumer for storage when a lampshade cover 602 is not in use. For example, the lid may include a plastic pop off cover.

Because the lampshade covers 502, 602 are formed from sheets thin enough to bend, they may be rolled in the manner illustrated. However, the lampshade covers 502, 602 are also thick enough to provide rigidity as a lampshade. In one embodiment, a design is printed on an interior surface of the lampshade covers 502, 602 to avoid scraping or scratching the design during packaging, shipping, and/or installation. In one embodiment, the design can be seen from an exterior surface due to a transparent or semitransparent substrate. In one embodiment, the design is opaque or semi-transparent to avoid glare from shining through the lampshade covers 502, 602 when installed.

Decorative lampshade wraps or covers may only take the shape, form and function of a lampshade after they have been purchased, received and removed from the delivery tube. In one embodiment, lampshade wraps or covers may be re-rolled and stored in the delivery tube when not in use or when being displaced by another wrap.

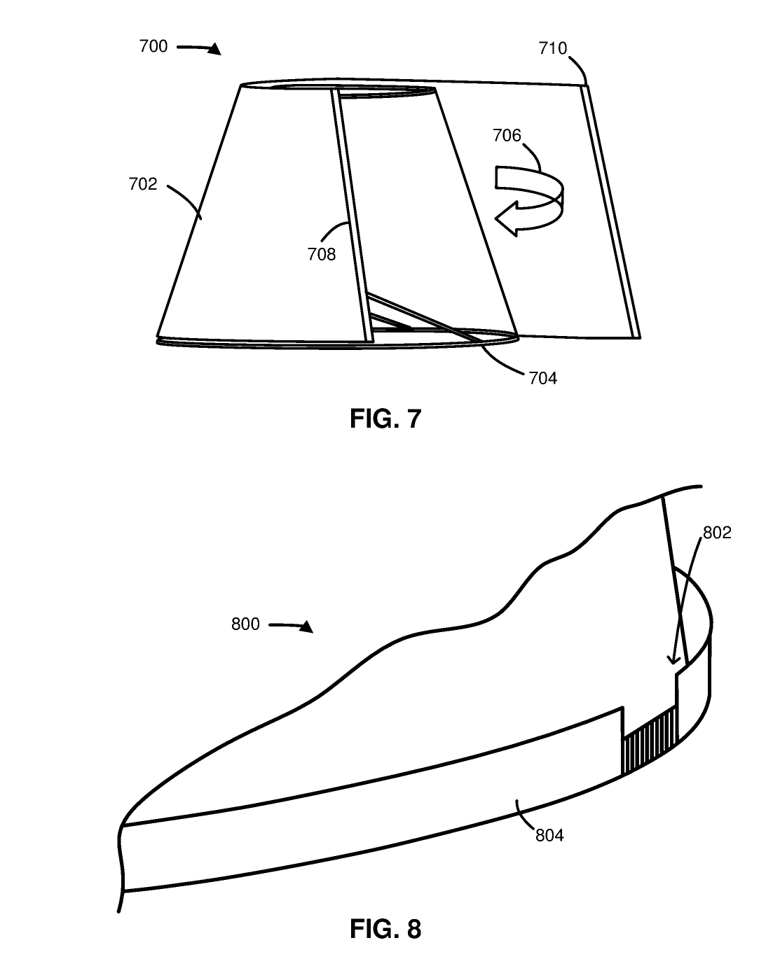

FIG. 7 is a perspective side view a lampshade system 700 showing installation or application of a lampshade cover 702 to a transparent lampshade 704 to create the lampshade system 700 for use on a lamp, according to one embodiment. The lampshade cover 702 may be wrapped around the transparent lampshade 704 as indicated by arrow 706. A fastener 708 on a first end and a fastener 710 on a second end may be attached to complete installation. The fasteners 708, 710 may include any type of fasteners such as hook and loop fasteners, magnetic tape, or the like. Once the fasteners 708, 710 are secured, the lampshade cover 702 may be supported by the transparent lampshade 704 to provide the lampshade 700 having the appearance similar to a conventional lampshade.

As will be clear in light of the disclosure, a large number of different types of dimensions and shapes may be achieved and is not limited to the illustrated shape. In one embodiment, the lampshade cover 702, with the fasteners 708, 710 attached, may be rigid enough to support its own weight in a lampshade configuration. Thus, exact matching between the transparent lampshade 704 or other support member may not be required as long as a lower edge or other portion of the lampshade cover 702 is supported by the transparent lampshade 704 or other support member. In the embodiment depicted in FIG. 7, the lampshade cover 702 matches a shape of the transparent lampshade 704 and the fasteners keep the lampshade cover 702 from sliding downward off the transparent lampshade 704. In other embodiments, a transparent lampshade 704, or other support member may provide a lip or groove to receive a lower edge of the lampshade cover 702.

FIG. 8 is an enlarged perspective view of a base of a transparent lampshade 800 having a channel or groove 802 for receiving a lower edge of a lampshade cover, according to one embodiment. The channel or groove 802 provides a gap between the transparent lampshade 800 and a lip 804. The lip 804 may extend from a base wire or ring so that there is a groove for receiving the lower edge of a lampshade cover or wrap. In one embodiment, the lip 804 is formed of a cloth, rigid plastic, metal, or other material. In one embodiment, the lip 804 extends about ¼ of an inch away from the base of the transparent lampshade 800.

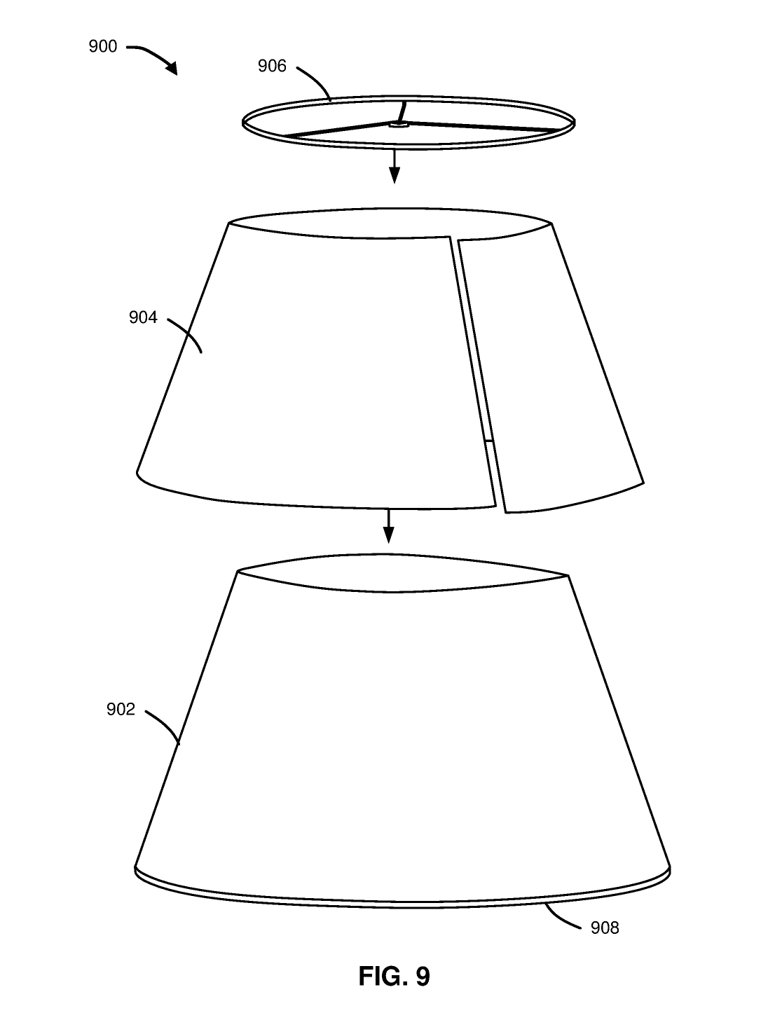

FIG. 9 illustrates an exploded view of a lampshade system 900, according to one embodiment. The lampshade system 900 includes a transparent lampshade base 902, a lampshade cover 904, and an upper support ring 906. The lampshade base 902 includes a lower lip 908 for accommodating a lower edge of the lampshade cover 904 and the upper support ring 906 may also include a lip for extending over an upper edge of the lampshade cover 904. The lampshade system 900 may be assembled with any lampshade cover 904 having a desirable pattern or design. The lampshade system 900 may be assembled by attaching the ends of the lampshade cover 904, dropping the lampshade cover 904 over the transparent lampshade base 902, placing the upper support ring 906 over the upper edge of the lampshade cover 904 and transparent lampshade base 902, and securing the upper support ring 906 in place using clips rivets, or other fasteners.

In one embodiment, embodiments and systems disclosed herein may be used with standardized sizes. For example, lamps, lampshade covers, and support members (e.g., transparent lampshades) may be manufactured and labeled in a plurality of predetermined sizes; for example, small, medium, large, kid sizes, and the like. In one embodiment, a lampshade system may provide a systemic lampshade frame having peripheral top and bottom flanges dimensioned and adapted to secure a systemic shade wrap or cover without tools, such as that illustrated in FIGS. 8 and 9. The lampshade system may include a color-coded format or a logo and branding format allowing users to easily identify the predetermined size of the plurality of components of the lampshade wrap or cover system.

A consumer may be able to select and or design a desired lampshade system using a computing system or electronic interface. For example, a consumer may select a size for a lampshade cover and then select a design or pattern to be printed on the lampshade. Based on the selections, a manufacturing system (such as the components in FIG. 2) may perform a manufacturing process to produce a customized lampshade wrap.

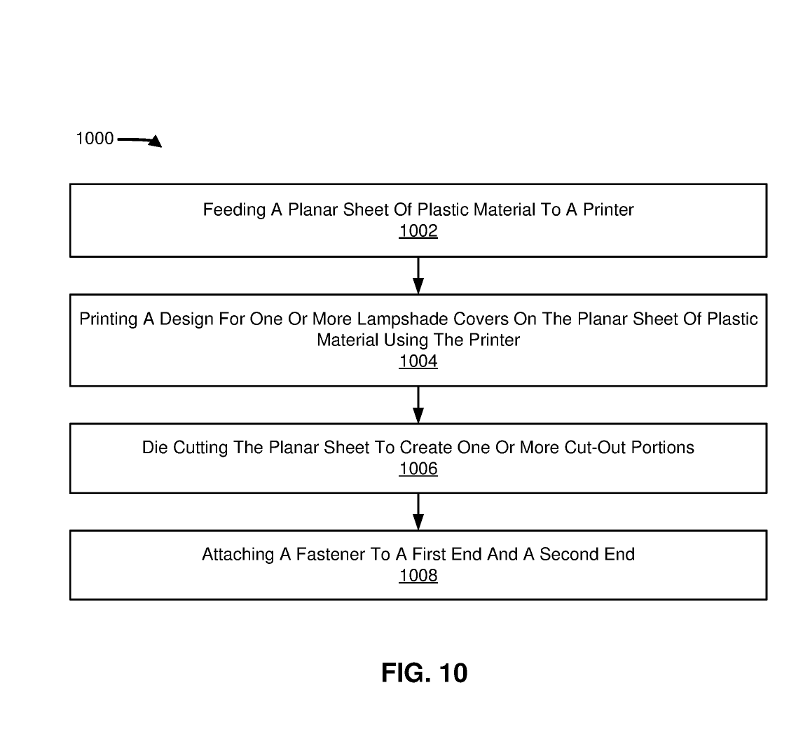

FIG. 10 is a schematic flow chart diagram illustrating an example method 1000 for manufacturing a lampshade cover or wrap. The method 1000 may be performed by a manufacturing system, such as the printer 204, die cut press 208, fastener applicator 212, control system 220 of FIG. 2.

The method 1000 begins and a roller or feed system feeds at 1002 a planar sheet of plastic material to a printer. The printer prints at 1004 a design for one or more lampshade covers on the planar sheet of plastic material. A die cut press cuts at 1006 the planar sheet to create one or more cut-out portions shaped to be bent, folded, or rolled into a three-dimensional lampshade cover shape. The cut-out portions including at least a portion of the design printed using the printer. A fastener applicator attaches at 1008 a fastener to a first end and a second end for selectively fastening the first end to the second end to hold the cut-out portions in the three-dimensional lampshade cover shape.

### EXAMPLES

The following examples pertain to further embodiments.

Example 1 is a method for manufacturing a lampshade cover. The method includes feeding a planar sheet of plastic material to a printer. The method includes printing a design for one or more lampshade covers on the planar sheet of plastic material using the printer. The method includes die cutting the planar sheet to create one or more cut-out portions shaped to be bent, folded, or rolled into a three-dimensional lampshade cover shape. The cut-out portions including at least a portion of the design printed using the printer. The method includes attaching a fastener to a first end and a second end for selectively fastening the first end to the second end to hold the cut-out portions in the three-dimensional lampshade cover shape.

In Example 2, the attaching the fastener to the first end and the second end includes as in Example 1 includes attaching the fastener directly to one or more of the first end and the second end using a glue or adhesive.

In Example 3, the attaching the fastener to the first end and the second end as in any of Examples 1-2 includes attaching magnetic tape to the first end or the second end.

In Example 4, the printing as in any of Examples 1-3 includes printing the design using an ultraviolet ink or powder and curing the ultraviolet ink or powered using an ultraviolet light source.

In Example 5, the ink or powder as in Example 4 includes a glow-in-the-dark ink or powder.

In Example 6, the printing as in any of Examples 1-5 includes lenticular printing on the planar sheet of plastic material to create a design including a holographic design.

In Example 7, the printing as in any of Examples 1-6 includes three-dimensional printing to add material to form a three-dimensional shape on the planar sheet of plastic material.

In Example 8, the planar sheet of plastic material as in any of Examples 1-7 includes a semi-rigid material that retains its shape when bent, folded, or rolled into the lampshade cover shape.

In Example 9, the design of any of Examples 1-8 is visible when the lampshade cover is in the lamp-shade cover shape.

In Example 10, the planar sheet as in any of Examples 1-9 is at least semi-transparent, wherein printing includes printing on an interior surface, and wherein when the cut-out portion is in the lampshade cover shape, the design on the interior of the lampshade cover shape is visible through the planar sheet from an exterior of the lampshade cover shape.

Example 11 is a lampshade cover prepared by a process including feeding a planar sheet of plastic material to a printer. The process includes printing a design for one or more lampshade covers on the planar sheet of plastic material using the printer. The process includes die cutting the planar sheet to create one or more cut-out portions shaped to be bent, folded, or rolled into a three-dimensional lampshade cover shape, the cut-out portions including at least a portion of the design printed using the printer. The process includes attaching a fastener to a first end and a second end to for selectively fastening the first end to the second end to form a three-dimensional lampshade cover shape.

In Example 12, the attaching the fastener to the first end and the second end as in Example 11 includes attaching the fastener directly to one or more of the first end and the second end using a glue or adhesive.

In Example 13, the printing as in any of Examples 11-12 includes printing the design using an ultraviolet ink or powder and curing the ultraviolet ink or powered using an ultraviolet light source.

In Example 14, the ink or powder of Example 13 includes glow in the dark ink or powder.

In Example 15, the printing as in any of Examples 11-14 includes lenticular printing on the planar sheet of plastic material to create a design including a holographic design.

In Example 16, the printing as in any of Examples 11-15 includes three-dimensional printing to add material to form a three-dimensional shape on the planar sheet of plastic material.

In Example 17, the planar sheet of plastic material as in any of Examples 11-16 includes one or more of styrene or polypropylene having a thickness greater than about 0.25 millimeters.

In Example 18, the planar sheet of plastic material as in any of Examples 11-17 includes a semi-rigid material that retains its shape when bent, folded, or rolled into the lampshade cover shape.

In Example 19, the planar sheet as in any of Examples 11-18 is at least semi-transparent, wherein printing in the process includes printing on an interior surface, and wherein when the cut-out portion is in the lampshade cover shape, the design on the interior surface of the lampshade cover shape is visible from an exterior of the lampshade cover shape.

In Example 20, the process as in any of Examples 11-19 further includes rolling up the cut-out-portion and storing in cylindrical tube.

Example 21 is a lampshade system a lampshade cover and a support member. The lampshade cover includes a sheet of plastic material including a first end and a second end. The lampshade cover includes a design printed on the plastic material. The lampshade cover includes a fastener configured to selectively fasten a first end of the sheet to a second end of the sheet to hold the lampshade cover in a three-dimensional lampshade shape, wherein the design is exposed for viewing when the lampshade cover is in the lampshade shape. The support member is configured to selectively receive and support the lampshade cover relative to a lamp body, the support member including one or more arms extending from the lamp body.

In Example 22, the support member as in Example 21 includes a transparent lampshade having a shape matching at least a portion of an inside of the three-dimensional lampshade shape to allow the lampshade cover to rest on and around the transparent lampshade while allowing light to pass through the transparent lampshade.

In Example 23, the support member as in any of Examples 21-22 includes a circular ring including a groove to selectively receive and support a lower edge of the lampshade cover when the fastener is secured to hold the lampshade cover when it is in the three-dimensional lampshade shape.

In Example 24, the groove of Example 21 is formed between a transparent lampshade and a lip extending from a lower edge of the transparent lampshade.

In Example 25, the one or more arms extending from the lamp body as in any of Examples 21-24 are positioned even with or below a top of a light source of a lamp mounted to the lamp body to avoid creating shadows above the light source.

In Example 26, the design as in any of Examples 21-25 is printed on an interior of the lampshade cover when the lampshade cover in the three-dimensional lampshade shape, wherein the sheet includes at least partially transparent material to allow the design to be seen from an exterior of the lampshade cover.

In Example 27, the fastener as in any of Examples 21-26 includes magnetic tape attached to the first end or the second end.

In Example 28, the lampshade cover as in any of Examples 21-27 is flexible to be rolled into a storage configuration.

Example 29 is a packaged lampshade cover. The packaged lampshade cover includes a lampshade cover that includes a sheet of plastic material including a first end and a second end. The lampshade cover includes a design printed on the plastic material. The lampshade cover includes a fastener configured to selectively fasten a first end of the sheet to a second end of the sheet to hold the lampshade cover in a three-dimensional lampshade shape, wherein the design is exposed for viewing when the lampshade cover is in the lampshade shape. The lampshade cover is selectively configurable into a lampshade shape and a storage configuration, wherein the fastener is released and the lampshade cover is rolled up in the storage configuration. The packaged lampshade cover includes a container and the lampshade cover is in the storage configuration within the container.

In Example 30, the lampshade cover of Example 29 is removable from the container.

In Example 31, the design as in any of Examples 29-30 includes a design printed using ultraviolet ink or powder.

In Example 32, the ink or powder as of Example 31 includes glow in the dark ink or powder.

In Example 33, the design as in any of Examples 29-32 includes a lenticular printed design including a holographic design.

In Example 34, the design as in any of Examples 29-33 includes a three-dimensional printed design printed using an additive printing process.

In Example 35, the sheet of plastic material as in any of Examples 29-34 includes a substantially uniform thickness greater than about 0.25 millimeters.

In Example 36, the sheet of plastic material as in any of Examples 29-35 includes a substantially uniform thickness, the thickness including from about 0.25 millimeters to about 0.55 millimeters.

In Example 37, the sheet of plastic material as in any of Examples 29-36 includes a substantially uniform thickness, the thickness including from about 0.35 millimeters to about 0.45 millimeters.

In Example 38, the sheet of plastic material as in any of Examples 29-37 includes a semi-rigid material that retains its shape when bent, folded, or rolled into the lampshade cover shape.

In Example 39, the sheet of plastic material as in any of Examples 29-38 is semi-transparent, wherein the design is printed on an interior surface, and wherein when the lampshade cover is in the lampshade cover shape, the design on the interior surface of the lampshade cover shape is visible through the sheet from an exterior of the lampshade cover shape.

Various techniques, or certain aspects or portions thereof, may take the form of program code (i.e., instructions) embodied in tangible media, such as floppy diskettes, CD-ROMs, hard drives, a non-transitory computer readable storage medium, or any other machine readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

1. A method for manufacturing a lamp shade cover, the method comprising:
feeding a planar sheet of plastic material to a printer;
printing a design for one or more lampshade covers on the planar sheet of plastic material using the printer;
die cutting the planar sheet to create one or more cut-out portions shaped to be bent, folded, or rolled into a three-dimensional lamp shade cover shape, the cut-out portions comprising at least a portion of the design printed using the printer; and
attaching a fastener to a first end and a second end for selectively fastening the first end to the second end to hold the cut-out portions in the three-dimensional lamp shade cover shape.

2. The method of claim 1, wherein attaching the fastener to the first end and the second end comprises attaching the fastener directly to one or more of the first end and the second end using a glue or adhesive.

3. The method of claim 1, wherein attaching the fastener to the first end and the second end comprises attaching magnetic tape to the first end or the second end.

4. The method of claim 1, wherein printing comprises:
printing the design using an ultraviolet ink or powder; and
curing the ultraviolet ink or powered using an ultraviolet light source.

5. The method of claim 4, wherein the ink or powder comprises a glow-in-the-dark ink or powder.

6. The method of claim 1, wherein printing comprises lenticular printing on the planar sheet of plastic material to create a design comprising a holographic design.

7. The method of claim 1, wherein printing comprises three-dimensional printing to add material to form a three-dimensional shape on the planar sheet of plastic material.

8. The method of claim 1, wherein the planar sheet of plastic material comprises a semi-rigid material that retains its shape when bent, folded, or rolled into the lamp shade cover shape.

9. The method of claim 1, wherein the design is visible when the lamp shade cover is in the lamp-shade cover shape.

10. The method of claim 1, wherein the planar sheet is semi-transparent, wherein printing comprises printing on an interior surface, and wherein when the cut-out portion is in the lamp shade cover shape, the design on the interior of the lamp shade cover shape is visible through the planar sheet from an exterior of the lamp shade cover shape.

11. A lamp shade cover prepared by a process comprising:
feeding a planar sheet of plastic material to a printer;
printing a design for one or more lampshade covers on the planar sheet of plastic material using the printer;
die cutting the planar sheet to create one or more cut-out portions shaped to be bent, folded, or rolled into a three-dimensional lamp shade cover shape, the cut-out portions comprising at least a portion of the design printed using the printer; and
attaching a fastener to a first end and a second end to for selectively fastening the first end to the second end to form a three-dimensional lamp shade cover shape.

12. The lamp shade cover of claim 11, wherein attaching the fastener to the first end and the second end in the process comprises attaching the fastener directly to one or more of the first end and the second end using a glue or adhesive.

13. The lamp shade cover of claim 11, wherein printing in the process comprises printing the design using an ultraviolet ink or powder and curing the ultraviolet ink or powered using an ultraviolet light source.

14. The lamp shade cover of claim 13, wherein the ink or powder comprises glow in the dark ink or powder.

15. The lamp shade cover of claim 11, wherein printing in the process comprises lenticular printing on the planar sheet of plastic material to create a design comprising a holographic design.

16. The lamp shade cover of claim 11, wherein printing in the process comprises three-dimensional printing to add material to form a three-dimensional shape on the planar sheet of plastic material.

17. The lamp shade cover of claim 11, wherein the planar sheet of plastic material comprises one or more of styrene or polypropylene having a thickness greater than about 0.25 millimeters.

18. The lamp shade cover of claim 11, wherein the planar sheet of plastic material comprises a semi-rigid material that retains its shape when bent, folded, or rolled into the lamp shade cover shape.

19. The lamp shade cover of claim 11, wherein the planar sheet is semi-transparent, wherein printing in the process comprises printing on an interior surface, and wherein when the cut-out portion is in the lamp shade cover shape, the design on the interior surface of the lamp shade cover shape is visible from an exterior of the lamp shade cover shape.

20. The lamp shade cover of claim 11, wherein the process further comprises rolling up the cut-out-portion and storing in cylindrical tube.
